(19) United States
(12) Patent Application Publication
(10) Pub. No.: US 2024/0426596 A1
(43) Pub. Date: Dec. 26, 2024

(54) SCANNER SYSTEM FOR THREE-DIMENSIONAL SCANNING OF MOVING OBJECTS

(71) Applicant: Northrop Grumman Systems Corporation, Falls Church, VA (US)

(72) Inventor: Grant Camden Miars, Detroit, MI (US)

(21) Appl. No.: 18/339,449

(22) Filed: Jun. 22, 2023

(51) Int. Cl. G01B 11/24; G06T 17/00

(52) U.S. Cl. CPC G01B 11/24; G06T 17/00; G06T 2200/08

(57) ABSTRACT

A scanner system includes a ring assembly having a stationary outer ring member and a rotating inner ring member. The rotating inner ring member is rotatable with respect to the stationary outer ring member. The scanner system also includes at least one scanner mounted to the rotating inner ring member. The scanner(s) is a laser scanner or an image scanner. The scanner system further includes a conveyor member for transporting a plurality of objects through the ring assembly. As such, the scanner(s) is configured to rotate with the rotating inner ring member to scan an exterior surface of the plurality of objects as the plurality of objects pass through the ring assembly so as to generate a three-dimensional (3D) model of each of the plurality of objects.

### FIELD

The present disclosure relates generally to scanner systems, and more particularly to a scanner system that provides circular three-dimensional scanning of moving objects.

### BACKGROUND

Modern manufacturing is a highly automated and precise process. The accuracy of modern machinery and growing fidelity of various three-dimensional (3D) printing methods promises new capabilities and increased quality products across all fields of man-made products. While most modern manufacturing processes use perfect 3D models and highly precise machines, these tools are only as good as the metrology used to measure the parts they actually produce. Object metrology provides tolerance, process tuning, and design process feedback which significantly increases the fidelity of the parts produced. Produced parts are traditionally inspected using handheld cameras or tools, such as calipers. More recent technologies have included laser line scanners which measure the height of an object as the laser moves past the object and handheld 3D scanners which produce 3D models using scans from multiple angles while being manipulated by human or mechanical arms. 3D scanning of single objects is also performed by placing the object on a platform and automatically rotating either the object or the platform. In some cases, 3D scanners may be moved linearly while the object is rotated on the platform. Thus, conventional scanning techniques are generally designed to either scan in two dimensions or 3D scan a single stationary/rotating object at a time. Both of these restrictions are problematic for manufacturing 3D parts cheaply at scale.

Accordingly, the present disclosure is directed to a scanner system capable of 3D scanning a high-volume of moving objects (such as objects from a manufacturing production line) quickly and easily.

### BRIEF DESCRIPTION

Aspects and advantages of the present disclosure will be set forth in part in the following description, or may be obvious from the description, or may be learned through practice of the present disclosure.

In an aspect, the present disclosure is directed to a scanner system. The scanner system includes a ring assembly having a stationary outer ring member and a rotating inner ring member. The rotating inner ring member is rotatable with respect to the stationary outer ring member. The scanner system also includes at least one scanner mounted to the rotating inner ring member. The scanner(s) is a laser scanner or an image scanner. The scanner system further includes a conveyor member for transporting a plurality of objects through the ring assembly. As such, the scanner(s) is configured to rotate with the rotating inner ring member to scan an exterior surface of the plurality of objects as the plurality of objects pass through the ring assembly so as to generate a three-dimensional (3D) model of each of the plurality of objects.

In another aspect, the present disclosure is directed to a scanner system. The scanner system includes a ring assembly having at least one ring member and at least one track mounted to the at least one ring member. The track(s) defines an arcuate pathway. Further, the scanner system includes at least one scanner movably mounted to the at least one track. The scanner(s) is a laser scanner or an image scanner. The scanner system further includes a conveyor member for transporting a plurality of objects through an opening of the ring assembly. As such, the scanner(s) is configured to move along at least a portion of the arcuate pathway of the track(s) to scan an exterior surface of the plurality of objects as each of the plurality of objects pass through the opening of the ring assembly so as to generate a three-dimensional (3D) model of each of the plurality of objects.

In yet another aspect, the present disclosure is directed to a method of scanning a plurality of objects via a scanner system. The method includes rotatably mounting at least one scanner of the scanner system to a rotating inner ring member of the scanner system. The rotating inner ring member is rotatable with respect to a stationary outer ring member of the scanner system. The scanner(s) is a laser scanner or an image scanner. The method further includes placing a plurality of objects on a conveyor member. The method also includes transporting the plurality of objects through a ring assembly of the scanner system via the conveyor member. In addition, the method includes rotating the scanner(s) via the rotating inner ring member. During rotation of the scanner(s), the method includes scanning an exterior surface of the plurality of objects as the plurality of objects pass through the ring assembly so as to generate a three-dimensional (3D) model of each of the plurality of objects.

These and other features, aspects and advantages of the present disclosure will be further supported and described with reference to the following description and appended claims. The accompanying drawings, which are incorporated in and constitute a part of this specification, illustrate embodiments of the disclosure and, together with the description, serve to explain the principles of the disclosure.

### BRIEF DESCRIPTION OF THE DRAWINGS

A full and enabling disclosure of the present disclosure directed to one of ordinary skill in the art, is set forth in the specification, which makes reference to the appended figures, in which:

FIG. 1A illustrates a perspective view of an embodiment of a scanner system according to the present disclosure;

FIG. 1B illustrates a top view of the scanner system of FIG. 1A;

FIG. 2A illustrates a front view of an embodiment of a scanner system having a ring assembly and a 3D scanner according to the present disclosure, particularly illustrating the 3D scanner in a first position;

FIG. 2B illustrates the front view of the scanner system of FIG. 2A, particularly illustrating the 3D scanner of the scanner system in a different, second position to show how the 3D scanner rotates via the ring assembly of the scanner system;

FIG. 3A illustrates a front view of an embodiment of a scanner system having a ring assembly and a plurality of 3D scanners according to the present disclosure, particularly illustrating the plurality of 3D scanners in a first orientation;

FIG. 3B illustrates the front view of the scanner system of FIG. 3A, particularly illustrating the plurality of 3D scanners in a different, second orientation to show how the plurality of 3D scanners rotate via the ring assembly of the scanner system;

FIG. 4 illustrates a front view of an embodiment of a scanner system having a ring assembly and a plurality of 3D scanners according to the present disclosure, particularly illustrating the plurality of 3D scanners being unevenly spaced about the ring assembly of the scanner system;

FIG. 5 illustrates a front view of an embodiment of a scanner system having a ring assembly and a plurality of 3D scanners according to the present disclosure, particularly illustrating a first 3D scanner on a first side of the ring assembly of the scanner system and a second 3D scanner on an opposing, second side of the ring assembly;

FIG. 6 illustrates a schematic diagram of an embodiment of a scanner system having a ring assembly and a 3D scanner according to the present disclosure, particularly illustrating an object being transported through the ring assembly via a gravity-assist channel;

FIG. 7 illustrates a block diagram of components that may be included in a controller of a scanner system according to the present disclosure;

FIG. 8 illustrates a front view of another embodiment of a scanner system having a ring assembly and a 3D scanner according to the present disclosure, particularly illustrating the ring assembly having a stationary outer ring member and a ring-shaped track mounted to the stationary outer ring member;

FIG. 9 illustrates a partial, internal view of an embodiment of a scanner system having a ring assembly and a 3D scanner according to the present disclosure, particularly illustrating a single ring-shaped track of the ring assembly coupled to a stationary outer ring member of the ring assembly;

FIG. 10 illustrates a partial, internal view of another embodiment of a scanner system having a ring assembly and a 3D scanner according to the present disclosure, particularly illustrating a plurality of ring-shaped tracks of the ring assembly mounted to a stationary outer ring member of the ring assembly; and

FIG. 11 illustrates a flow diagram of an embodiment of a method of scanning a plurality of objects via a scanner system according to the present disclosure.

### DETAILED DESCRIPTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

Modern manufacturing is a highly automated and precise process. The accuracy of modern machinery and growing fidelity of various 3D printing methods promises new capabilities and increased quality products across all fields of man-made products. While most modern manufacturing uses perfect 3D models and highly precise machines, these tools are only as good as the metrology used to measure the parts they actually produce. Object metrology provides tolerance, process tuning, and design process feedback which significantly increases the fidelity of parts produced. Produced parts are traditionally inspected using handheld cameras or tools such as calipers. More recent technologies include stationary laser line scanners which measure the height of an object as the object moves past the fixed laser and handheld 3D scanners which produce 3D models using scans from multiple angles while being manipulated by human or mechanical arms. 3D scanning of single objects is also performed by placing the object on a stationary platform and automatically rotating either the object or the platform. In some cases, the 3D scanner may be moved linearly while the object is rotated on the platform. However, such processes are not able to 3D scan a high-volume of moving objects (such as those from a manufacturing production line) quickly and easily. Rather, conventional techniques are generally designed to scan in two dimensions or 3D scan a single stationary/rotating object at a time. Both of these restrictions are highly problematic for manufacturing 3D parts cheaply at scale.

Accordingly, in an embodiment, the present disclosure is generally directed to a scanner system having a ring assembly with a stationary outer ring member and a rotating inner ring member and a 3D scanner mounted to the rotating inner ring member so as to scan and render 3D models of objects (such as the exterior surface of the objects) as they pass through a center of the ring assembly, e.g., via a conveyor member. More specifically, in an embodiment, the ring assembly (and thus the rotating inner ring member) has a center opening in which the 3D scanner is mounted on an inner diameter of the rotating inner ring member. Thus, the scanner system of the present disclosure is able to automatically scan a high-volume of objects as the objects pass through the center opening of the rotating inner ring member. In particular embodiments, the scanner system of the present disclosure can be implemented to scan manufactured parts as the parts pass through on a production line. The 3D models generated can then be automatically compared to the original 3D model for quality control purposes. The scanner system of the present disclosure can also be used to scan any other objects in any other applications in high-volume, automatic 3D scanning, such as fruit quality control, human 3D model generation, rocket part tolerance measurements, or any other application that can benefit from the scanning techniques described herein.

Any suitable 3D scanner may be used, such as a laser scanner, an imaging scanner, or combinations thereof. As such, in an embodiment, the 3D scanner rotates about the center opening of the rotating inner ring member, while pointing towards the object(s). In some embodiments, the 3D scanner can be mounted on a rotating track or the entire inner diameter of the ring assembly (referred to herein as the rotating inner ring member) may be allowed to move relative to the outer ring member (which remains stationary). Thus, in an embodiment, objects are passed through the opening of the rotating inner ring member and 3D scanned from all directions as the objects pass therethrough. Accordingly, in an embodiment, reconstruction software can be used to convert collected data from the 3D scanner into a 3D model of the object(s). Supporting equipment, such as conveyer member, may be removed in this post-processing step. These 3D models may then be viewed, compared to the desired 3D model, compared to each other, etc.

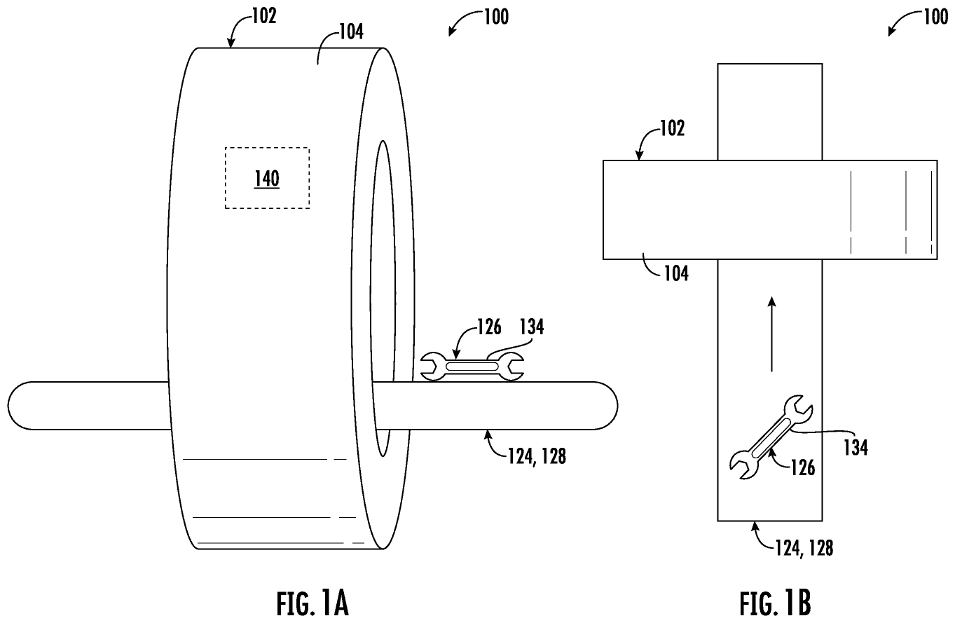

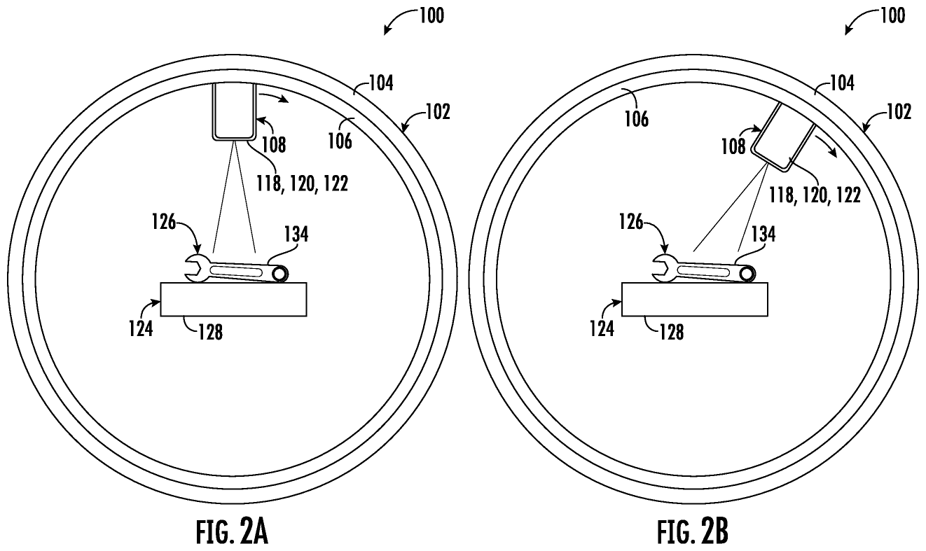

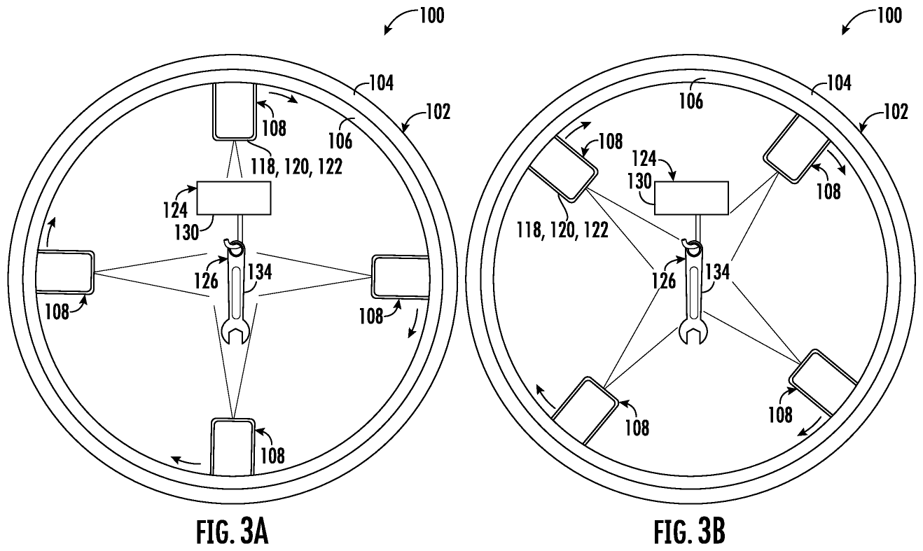

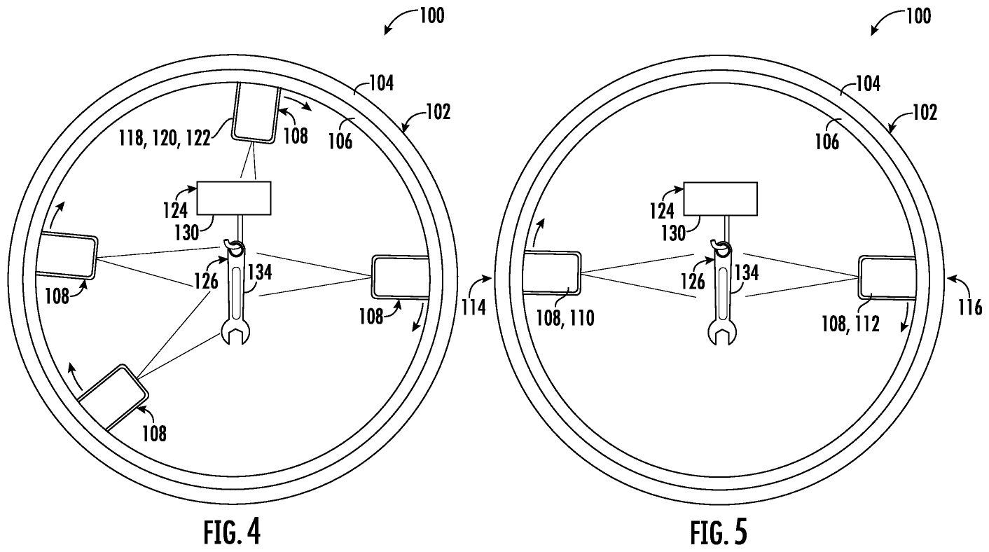

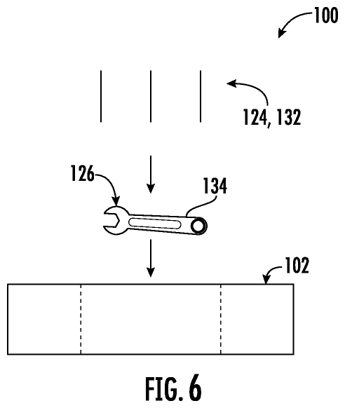

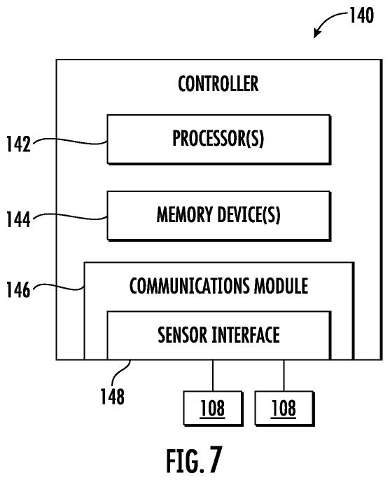

Referring now to the drawings, FIGS. 1A-7 illustrate various views of an embodiment of a scanner system 100 for scanning a plurality of objects according to the present disclosure are illustrated. In particular, FIG. 1A illustrates a simplified, side perspective view of an embodiment of the scanner system 100 according to the present disclosure; FIG. 1B illustrates a top view of the scanner system 100 shown in FIG. 1A; FIGS. 2A and 2B illustrate front views of an embodiment of a scanner system 100 according to the present disclosure; FIGS. 3A and 3B illustrate front views of another embodiment of a scanner system 100 according to the present disclosure; FIG. 4 illustrates a front view of another embodiment of a scanner system 100 according to the present disclosure; FIG. 5 illustrates a front view of still another embodiment of a scanner system 100 according to the present disclosure; FIG. 6 illustrates a schematic diagram of yet another embodiment of a scanner system 100 according to the present disclosure; and FIG. 7 illustrates a block diagram of components that may be included in a controller of a scanner system according to the present disclosure.

Accordingly, as shown generally in FIGS. 1A-5, the scanner system 100 includes a ring assembly 102 having a stationary outer ring member 104 and a rotating inner ring member 106. Further, as shown, the rotating inner ring member 106 is rotatable with respect to the stationary outer ring member 104. More specifically, as shown generally in FIGS. 2A-5, the stationary outer ring member 104 and the rotating inner ring member 106 are concentric with each other. In addition, in an embodiment, the rotating inner ring member 106 may be rotatable with respect to the stationary outer ring member 104 using any suitable means, such as via a plurality of roller elements (e.g., ball bearings) or a track arranged between the stationary outer ring member 104 and the rotating inner ring member 106.

In addition, as shown, the scanner system 100 includes at least one scanner 108 mounted to the rotating inner ring member 106. According, the scanner(s) 108 is configured to rotate about a rotational axis R at any suitable speed. In an embodiment, for example, the scanner(s) 108 is configured to rotate at a constant rotational speed in a clockwise direction and/or a counterclockwise direction. In another embodiment, the scanner(s) 108 is configured to rotate at a variable speed in the clockwise direction and/or the counterclockwise direction.

More specifically, in an embodiment, as shown in FIGS. 2A and 2B, the scanner system 100 may include a single scanner 108 mounted to the rotating inner ring member 106. In another embodiment, as shown in FIGS. 3A-5, the scanner system 100 may include a plurality of scanners 108 mounted to and arranged circumferentially around the rotating inner ring member 106. Furthermore, as shown in FIGS. 3A and 3B, the plurality of scanners 108 may be evenly spaced circumferentially around the rotating inner ring member 106. In one embodiment, as shown in FIG. 5, the plurality of scanners may include, at least, a first scanner 110 and a second scanner 112. Further, as shown, the first and second scanners 110, 112 are mounted to first and second locations on the rotating inner ring member 106, respectively, with the first and second locations 114, 116 being on opposite sides of the rotating inner ring member 106. In another embodiment, as shown in FIG. 5, the plurality of scanners 108 may be unevenly spaced circumferentially around the rotating inner ring member 106.

In an embodiment, for example, the scanner(s) 108 may be a laser scanner 118, an image scanner 120, or any other suitable 3D scanner. As used herein, 3D scanning generally refers to the process of analyzing a real-world object or environment to collect three-dimensional data of its shape and possibly its appearance (e.g., color). The collected data can then be used to construct digital 3D models. For example, in an embodiment, the laser scanner 118 may be a triangulation laser scanner, a structured light laser scanner, a pulse laser scanner (or time-of-flight laser scanner), a modulating light laser scanner, or any other suitable laser scanner. A triangulation laser scanner generally refers to an active laser scanner that uses laser light to probe the environment by shining a laser on the object and a camera to observe the location of the laser dot. A structured light laser scanner generally refers to a laser scanner that projects a pattern of light on the object to observe the deformation of the pattern on the object via a camera. A pulse laser scanner generally refers to an active laser scanner that uses laser light to probe the object and a laser range finder that finds the distance of a surface of the object by timing the round-trip time of a pulse of light. As such, the pulse laser scanner is used to emit a pulse of light and the amount of time before the reflected light is seen by a detector is measured. A modulated light laser scanner generally refers to a laser scanner that shines a continually changing light at an object, with the light source cycling its amplitude in a sinusoidal pattern and a camera detecting the reflected light and the amount the pattern is shifted by determining the distance the light travelled.

Moreover, in an embodiment, the image scanner 120 may include at least one camera 122 for generating the 3D model. In such embodiments, the camera(s) 122 may be part of at least one of a multi-photo imaging system, a photogrammetric imaging system, a stereoscopic imaging system, or a silhouette imaging system.

In addition, in an embodiment, the scanner system 100 includes a conveyor member 124 for transporting a plurality of objects 126 through the ring assembly 102. For example, in an embodiment, as shown in FIGS. 1A-2B, the conveyor member 124 may include a conveyor belt 128. In another embodiment, as shown in FIGS. 3A-4, the conveyor member 124 may be an overhead conveyor 130. In still another embodiment, as shown in FIG. 6, the conveyor member 124 may be a gravity-assist channel 132. Thus, in an embodiment, the scanner(s) 108 is configured to rotate with the rotating inner ring member 106 to scan an exterior surface 134 or geometry of the plurality of objects 126 as the plurality of objects 126 pass through the ring assembly 102 so as to generate a 3D model of each of the plurality of objects 126.

Referring particularly to FIGS. 1A and 7, the scanner system 100 may also include a controller 140 for controlling the various components of the scanner system 100 and for generating a 3D model of each of the objects. As shown in FIG. 7, a block diagram of components that may be included with the controller 140 according to the present disclosure is illustrated. As shown, the controller 140 may include one or more processors 142 and one or more memory devices 144 configured to perform a variety of computer-implemented functions (e.g., performing the methods, steps, calculations and the like and storing relevant data as disclosed herein). Additionally, the controller 140 may also include a communications module 146 to facilitate communications between the controller 140 and the scanner(s) 108 described herein.

Further, as shown, the communications module 146 may include a sensor interface 148 (e.g., one or more analog-to-digital converters) to permit signals transmitted from the scanner(s) 108 to be converted into signals that can be understood and processed by the processor(s) 142. It should be appreciated that the scanner(s) 108 may be communicatively coupled to the communications module 146 using any suitable means. For example, as shown in FIG. 7, the scanner(s) 108 may be coupled to the sensor interface 148 via a wired connection. However, in other embodiments, the scanner(s) 108 may be coupled to the sensor interface 148 via a wireless connection, such as by using any suitable wireless communications protocol known in the art. As such, the processor(s) 142 may be configured to receive one or more signals from the scanner(s) 108.

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. The processor(s) 142 may also be configured to compute advanced control algorithms and communicate to a variety of Ethernet or serial-based protocols (Modbus, OPC, CAN, etc.) as well as classical analog or digital signals. Additionally, the memory device(s) 144 may generally include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 144 may generally be configured to store suitable computer-readable instructions that, when implemented by the processor(s) 142, configure the controller 140 to perform the various functions as described herein.

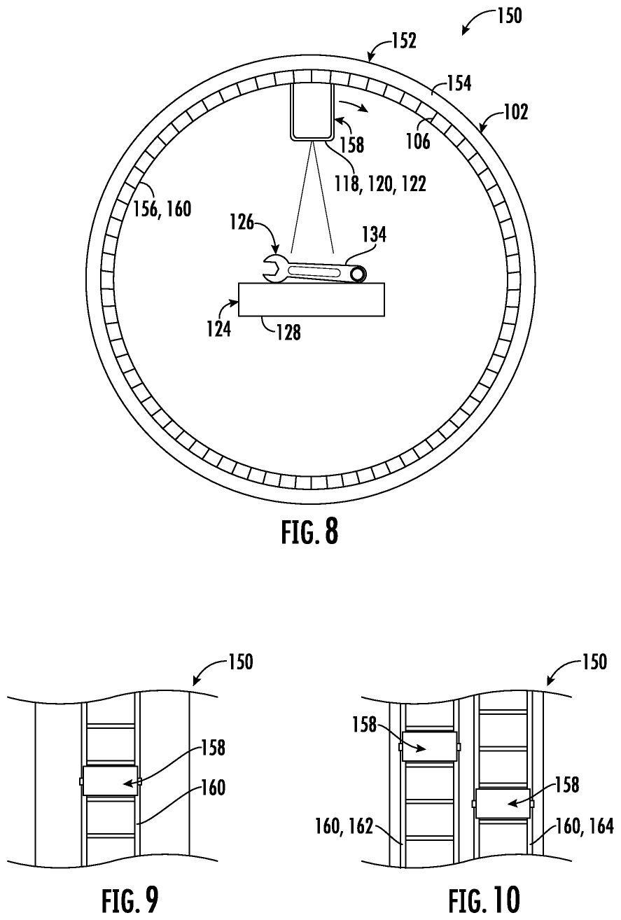

Referring now to FIGS. 8-10, various views of another embodiment of a scanner system 150 for scanning a plurality of objects according to the present disclosure are illustrated. In particular, FIG. 8 illustrates a front view of another embodiment of a scanner system 150 according to the present disclosure is illustrated. FIG. 9 illustrates a partial, internal view of an embodiment of a scanner system 150 according to the present disclosure. FIG. 10 illustrates a partial, internal view of another embodiment of a scanner system 150 according to the present disclosure.

In particular, as shown in FIG. 8, the scanner system 150 includes a ring assembly 152 having a stationary outer ring member 154 and an inner ring member 156, with the inner ring member 156 being at least one ring-shaped track 160 mounted to the stationary outer ring member 154. Further, as shown, the stationary outer ring member 154 and the ring-shaped track 160 are concentric with each other. Thus, in an embodiment, as shown, the ring-shaped track 160 defines an arcuate pathway. In such embodiments, as shown, the scanner system 150 may also include at least one scanner 158, such as any of the scanners described herein, moveably mounted to the ring-shaped track 160. Accordingly, in an embodiment, the scanner(s) 108 is configured to move along at least a portion of the arcuate pathway and rotate about the ring-shaped track 160.

In certain embodiments, as shown in FIG. 9, the scanner system 150 may include a single ring-shaped track 160 mounted to the stationary outer ring member 154. In another embodiment, as shown in FIG. 10, the scanner system 150 may include a plurality of ring-shaped tracks 160 mounted to the stationary outer ring member 154. In such embodiments, for example, and as shown in FIG. 10, each of the plurality of ring-shaped tracks 160 may include at least one of the plurality of scanners 158 mounted thereto. Moreover, in an embodiment, as shown in FIG. 10, the plurality of ring-shaped tracks 160 include, at least, a first ring-shaped track 162 and a second ring-shaped track 164. In such embodiments, the first and second ring-shaped tracks 162, 164 may be configured to rotate the scanner(s) 108 mounted thereto in the same direction, in opposite directions, or combinations thereof (e.g., if more than two tracks are present, one or more tracks can rotate in the same direction and one or more tracks can rotate in the opposite direction.

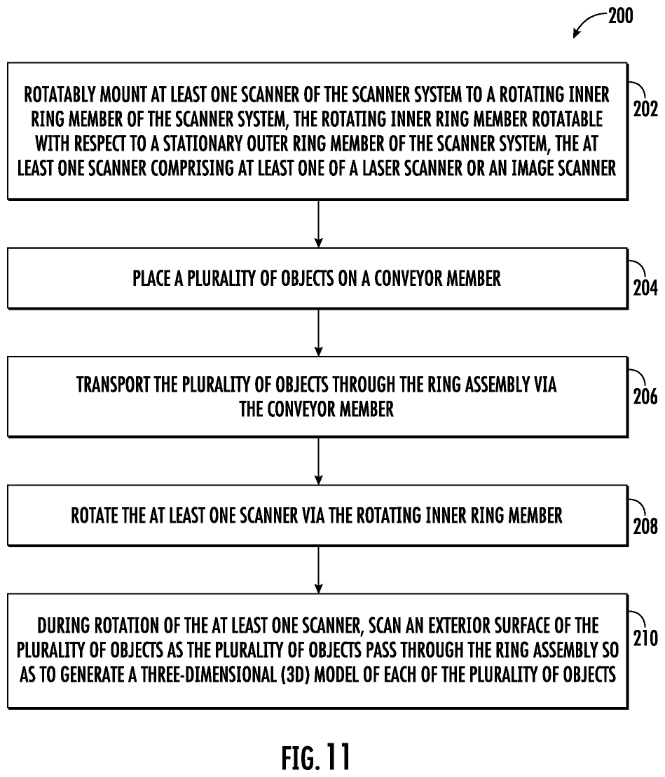

Referring now to FIG. 11, a flow diagram of an embodiment of a method 200 of scanning a plurality of objects via a scanner system according to the present disclosure is illustrated. In general, the method 200 will be described herein with reference to the scanner systems 100, 150 illustrated in FIGS. 1-10. However, it should be appreciated that the disclosed method 200 may be implemented with any scanner system having any other suitable configurations. In addition, although FIG. 11 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown at (202), the method 200 includes rotatably mounting at least one scanner of the scanner system to a rotating inner ring member of the scanner system. As mentioned, the rotating inner ring member is rotatable with respect to a stationary outer ring member of the scanner system and the scanner(s) includes at least one of a laser scanner or an image scanner. As shown at (204), the method 200 includes placing a plurality of objects on a conveyor member. As shown at (206), the method 200 includes transporting the plurality of objects through the ring assembly via the conveyor member. As shown at (208), the method 200 includes rotating the scanner(s) via the rotating inner ring member. During rotation of the scanner(s), as shown at (210), the method 200 includes scanning an exterior surface of the plurality of objects as the plurality of objects pass through the ring assembly so as to generate a 3D model of each of the plurality of objects.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A scanner system, comprising:
a ring assembly comprising a stationary outer ring member and a rotating inner ring member, the rotating inner ring member rotatable with respect to the stationary outer ring member;
at least one scanner mounted to the rotating inner ring member, the at least one scanner comprising at least one of a laser scanner or an image scanner;
a conveyor member for transporting a plurality of objects through the ring assembly,
wherein, the at least one scanner is configured to rotate with the rotating inner ring member to scan an exterior surface of the plurality of objects as the plurality of objects pass through the ring assembly so as to generate a three-dimensional (3D) model of each of the plurality of objects.

2. The scanner system of claim 1, wherein the laser scanner comprises at least one of a triangulation laser scanner, a structured light laser scanner, a pulse laser scanner, or a modulating light laser scanner.

3. The scanner system of claim 1, wherein the image scanner comprises at least one camera for generating the 3D model.

4. The scanner system of claim 3, wherein the at least one camera is part of at least one of a multi-photo imaging system, a photogrammetric imaging system a stereoscopic imaging system, or a silhouette imaging system.

5. The scanner system of claim 1, wherein the conveyor member comprises at least one of a conveyor belt, an overhead conveyor, or a gravity-assist channel.

6. The scanner system of claim 1, further comprising a plurality of scanners mounted to and arranged circumferentially around the rotating inner ring member, the at least one scanner being one of the plurality of scanners.

7. The scanner system of claim 6, wherein the plurality of scanners are evenly spaced circumferentially around the rotating inner ring member.

8. The scanner system of claim 6, wherein the plurality of scanners are unevenly spaced circumferentially around the rotating inner ring member.

9. The scanner system of claim 6, wherein the plurality of scanners comprises, at least, a first scanner and a second scanner, the first and second scanners mounted to first and second locations on the rotating inner ring member, respectively, the first and second locations being on opposite sides of the rotating inner ring member.

10. The scanner system of claim 1, wherein the at least one scanner rotates at a constant rotational speed in one of a clockwise direction or a counterclockwise direction.

11. The scanner system of claim 1, wherein the at least one scanner rotates at a variable speed in one of a clockwise direction or a counterclockwise direction.

12. The scanner system of claim 1, wherein the stationary outer ring member and the rotating inner ring member are concentric, the rotating inner ring member rotatable with respect to the stationary outer ring member via a plurality of roller elements arranged between the stationary outer ring member and the rotating inner ring member.

13. The scanner system of claim 1, wherein the rotating inner ring member comprises a ring-shaped track mounted to the stationary outer ring member, the at least one scanner mounted to the ring-shaped track.

14. The scanner system of claim 6, wherein the rotating inner ring member comprises a plurality of ring-shaped tracks mounted to the stationary outer ring member, wherein each of the plurality of ring-shaped tracks comprises at least one of the plurality of scanners mounted thereto, the plurality of ring-shaped tracks comprising, at least, a first ring-shaped track and a second ring-shaped track.

15. The scanner system of claim 14, wherein the first and second ring-shaped tracks are configured to rotate in opposite directions.

16. A scanner system, comprising:
a ring assembly comprising at least one ring member and at least one track mounted to the at least one ring member, the at least one track defining an arcuate pathway;
at least one scanner movably mounted to the at least one track, the at least one scanner comprising at least one of a laser scanner or an image scanner;
a conveyor member for transporting a plurality of objects through an opening of the ring assembly,
wherein, the at least one scanner is configured to move along at least a portion of the arcuate pathway of the at least one track to scan an exterior surface of the plurality of objects as each of the plurality of objects pass through the opening of the ring assembly so as to generate a three-dimensional (3D) model of each of the plurality of objects.

17. A method of scanning a plurality of objects via a scanner system, the method comprising:
rotatably mounting at least one scanner of the scanner system to a rotating inner ring member of the scanner system, the rotating inner ring member rotatable with respect to a stationary outer ring member of the scanner system, the at least one scanner comprising at least one of a laser scanner or an image scanner;
placing a plurality of objects on a conveyor member;
transporting the plurality of objects through a ring assembly of the scanner system via the conveyor member;
rotating the at least one scanner via the rotating inner ring member; and
during rotation of the at least one scanner, scanning an exterior surface of the plurality of objects as the plurality of objects pass through the ring assembly so as to generate a three-dimensional (3D) model of each of the plurality of objects.

18. The method of claim 17, wherein the laser scanner comprises at least one of a triangulation laser scanner, a structured light laser scanner, a pulse laser scanner, or a modulating light laser scanner.

19. The method of claim 17, wherein the image scanner comprises at least one camera for generating the 3D model, the at least one camera being part of at least one of a multi-photo imaging system, a photogrammetric imaging system a stereoscopic imaging system, or a silhouette imaging system.

20. The method of claim 17, wherein the conveyor member comprises at least one of a conveyor belt, an overhead conveyor, or a gravity-assist channel.
